(19) United States
(12) Patent Application Publication
(10) Pub. No.: US 2002/0070056 A1
(43) Pub. Date: Jun. 13, 2002

(54) Steering traction control apparatus for a work machine

(76) Inventor: Arlyn P. Wilcox, Rockford, IL (US)

Correspondence Address: Jeff A. Greene, Caterpillar Inc., Intellectual Property Department, 100 N.E. Adams Street, AB6490, Peoria, IL, 61629-6490, US

(21) Appl. No.: 09/732,156

(22) Filed: Dec. 7, 2000

(51) Int. Cl. B62D 11/02

(52) U.S. Cl. 180/6.7; 180/9.44

(57) ABSTRACT

A steering traction control apparatus for a track laying work machine includes first and second speed sensors that produce a slip signal responsive to the difference in rotational velocity of first and second axles. A controller receives the slip signal and responsively supplies a steering output signal in response to the magnitude of the slip signal.

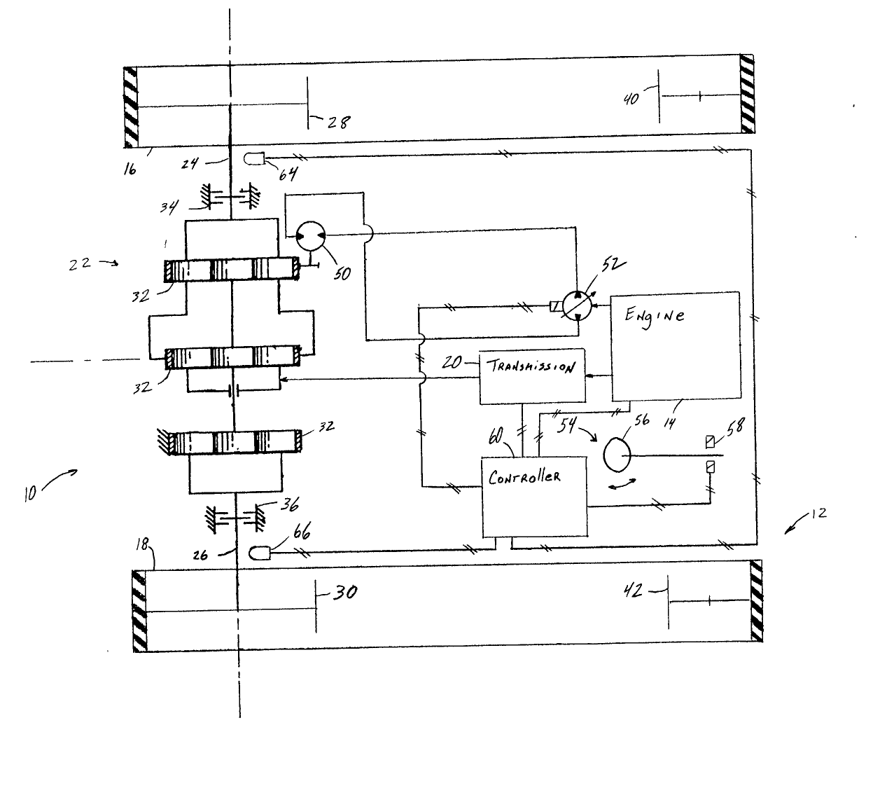

### TECHNICAL FIELD

This invention relates generally to track laying work machines and more particularly, to an apparatus and method for controlling steering traction on a differentially steered track laying work machine.

### BACKGROUND ART

Track laying work machines are used in many off road applications such as construction and agriculture. A variety of soil conditions are experienced by the track laying work machines during operation. Problem areas during operation are loose or wet soil, which often cause the work machine to experience loss of traction. Loss of traction can cause one or both of the tracks to lose power-transmitting engagement with the ground.

The loss of power-transmitting engagement with the ground or slip is especially of concern when the operator performs a turning operation. Planetary steering differentials are commonly used to steer track laying work machines through a plurality of interconnected planetary mechanisms. Power is transferred from the engine through a transmission to the steering differential. The steering differential includes a plurality of interconnected planetary mechanisms and a fluid motor that is used to rotate one or more of the interconnected planetary mechanisms to perform a steering operation. By rotating one or more of the interconnected planetary mechanisms the speed of one track is increased while the speed of the other track is reduced by an equal rate causing the work machine to maneuver through a desired radius.

The steering differential works to maneuver the work machine through a desired radius or turn in normal working conditions. However, when a track laying work machine encounters loose or wet soil, slip can occur with one or both tracks during a turn. This slip causes the work machine not to turn in the manner desired by the operator. When slip occurs the operator's natural instinctive reaction is to try to input a greater steering command to obtain the desired turn. The increase in the steering command takes power from one track and transmits the available power to the opposite track. This can cause and adverse affect especially when the track receiving power is the track that is already experiencing slip.

Many different systems have been used to detect track slip. One such system is disclosed in U.S. Pat. No. 5,287,280 issued Feb. 15, 1994 and assigned to Kabushiki Kaisha Komatsu. The system discloses using an acceleration detection device, to measure the actual machine acceleration. A travelling speed computing circuit is used to calculate the actual vehicle speed on the basis of the machine acceleration. A track slip ratio computing circuit is used to calculate the track slip ratio from the actual vehicle speed and the track traveling speed and an engine output control circuit for switching the engine output mode on the basis of the calculated track slip ratio. The system switches to a predetermined engine output mode when a shoe slip ratio exceeds a predetermined value during operation. However, this system is complicated and requires multiple inputs, computations and comparisons thus increasing the likelihood of error and component failure.

The present invention is directed to overcoming one or more of the problems as set forth above.

### DISCLOSURE OF THE INVENTION

In one aspect of the present invention a steering traction control apparatus is provided for a track laying work machine. The work machine is supported on and operatively driven by first and second endless tracks. The steering traction control apparatus comprises a first speed sensor produces a slip signal having a value responsive to the velocity of the first axle. A second speed sensor produces a slip signal having a value responsive to the velocity of the second axle. A controller receives the slip signal and responsively supplies a steering output signal in response to the slip signal.

In another aspect of the present invention a method is provided for controlling steering traction of a track laying work machine. The track laying work machine is supported on and driven by first and second endless tracks. First and second endless tracks are driven by first and second axles. The method includes the following steps. Producing a slip signal having a value responsive to the difference in velocity between the first and second axles. Receiving the slip signal and producing a steering command signal in response to the magnitude of said slip signal.

### Brief DESCRIPTION OF THE DRAWINGS

The sole drawing shows a schematic of a steering traction control apparatus for a track laying work machine in accordance with the present invention.

### BEST MODE FOR CARRYING OUT THE INVENTION

Referring to the drawing, a steering traction control apparatus 10 embodying certain principles of the present invention is illustrated. A track laying work machine 12 is illustrated that is powered by an engine 14 and supported on first and second endless tracks 16,18. Engine 14 transmits power through a transmission 20 to a differential steering arrangement 22, which is connected to first and second axles 24,26. The first and second axles 24,26 are respectively drivingly connected to drive wheels 28,30. Differential steering arrangement 22 includes a plurality of interconnected planetary mechanisms 32 connected between the transmission 20 and the drive wheels 28,30. The differential steering arrangement 22 also includes service brakes 34,36 connected with respective first and second axles 24,26. The track laying work machine 12 may have “inboard” or “outboard” service brakes and final drive units. For example, as shown the outermost planetary mechanisms 32 are final reduction drive units and the service brakes 34,36 are located inboard and positioned within the differential steering arrangement 22. Alternatively, the outboard assembly (not shown) includes the braking mechanisms and final drives located within the drive wheels.

As shown, the first and second endless tracks 16,18 respectively entrained about drive wheels 28,30 and idler wheels 40,42. Tensioning the idler wheels 40,42 provides frictional engagement of the first and second endless tracks 16,18 with the drive wheels 28,30 thus supplying motive force for the work machine 12. In the present invention tensioning the idler wheels 40,42 is provided through tensioning arrangements (not shown). Alternatively, the motive force is provided through drive sprockets (not shown) that engagingly mesh with the endless tracks. The drive system disclosed is known and no further details need be disclosed for an understanding of the present invention.

The differential steering arrangement 22 includes a fluid motor 50 that is hydrostatically coupled to a steering pump 52. The fluid motor 50 is operatively connected to one of the plurality of interconnected planetary mechanisms 32 for controlably changing the rotational velocity of the first and second axles 24,26. The steering pump 52 is operatively connected to and powered by the engine 14. The steering pump 52 supplies pressurized fluid to the fluid motor 50 in a first direction increasing the speed of the first endless track 16 and slowing the speed of the second endless track 18, thus enabling the machine to maneuver a right turn. The fluid motor 50 is actuated in a second direction increasing the speed of the second endless track 18 and slowing the speed of the first endless track 16, thus enabling the machine to maneuver a left turn.

An operator provides the steering command through an input device 54. The input device 54 is a steering wheel 56 that is operatively connected to a sensor 58. Sensor 58 is a rotary sensor or other known means for converting a manual input command into an electrical signal responsive to the magnitude of the input command. The sensor 58 is connected to and transmits the electrical signal to a controller 60. The controller 60 is in turn connected to the steering pump 52.

The steering traction control apparatus 10 produces a slip signal having a value responsive to the difference in rotational velocity between the first and second axles 24,26 respectively. As shown the steering traction control apparatus 10 includes first and second speed sensors 64,66 positioned adjacent to the first and second axles 24,26. Alternatively, the first and second sensors 64,66 (not shown) measure the rotational velocity of the drive wheels 28,30 without departing from the spirit of the present invention. The signals from the first and second speed sensors 64,66 are applied to an input of the electronic controller 60, the details of which are described below. It should also be understood that other work machine components are connected to and communicate with the controller 60 such as the engine 14, transmission 20.

Sensors 64,66 produce respective signals having values responsive to the rotational speed or velocity of the first and second axles 24,26. The axle speed signals for each of the first and second axle 24,26 are provided in a similar manner and are applied to an input of the controller 60. For example, each sensor 64,66 is a transducer that produces a pulse-type time variable output voltage. Such transducers are well known in the art. However, other transducers, such as optical and electromagnetic devices, may be employed as alternatives.

The controller 60 operates upon the signal inputs, determines the existence, magnitude, and location slip during a loss of traction situation, and distinguishes between true slip and application of service brakes 34,36 or a transducer failure. In response to detecting a slip condition, the controller 60 controllably transforms the slip signal into a steering pump 52 output command, in response to the magnitude of the slip signal. The power transfer between the differentially driven tracks 16,18 is balanced by the controller 60 overriding the operator input command and controlling the steering pump 52 output responsive to the magnitude of the slip signal.

While the discussion has specifically described the present invention as being used to control traction during a steering operation, it should be understood that the system controls slip between the drive wheels 28,30 and the endless tracks 16,28 and during any operational mode of the work machine 12.

Industrial Applicability

In operation, the operator inputs a steering command into the input mechanism 54 the sensor 58 sends a command to the controller 60 responsive to the magnitude of the operators input. The controller 60 controllably sends a signal to the steering pump 52, causing the steering pump 52 to supply pressurized fluid to the fluid motor 50 to appropriately change the speed of the first and second endless tracks 16,18 responsive to the direction of the desired turn. For example, if a right hand turn is desired the speed of the outside or first endless track 16 (corresponding to the drawing) is increased and the inner or second endless track 18 decreased. Ideally, the first and second endless tracks 16,18 change speed in equal proportions to one another, i.e. the outside track 16 increases in speed at the same rate the inside track 18 decreases in speed.

During a turning operation the controller 60 receives the slip signal from the first and second sensors 64,66. As stated earlier if the slip signal is determined as true slip and is beyond a predetermined upper limit, the controller 60 limits the steering input from the input mechanism 54 as supplied by sensor 58. The controller 60 reduces the steering output command supplied to the steering pump 52, thus slowing the velocity of the track that is experiencing the slip. By limiting the supply of pressurized fluid to the motor 50 the power transmitted to the track that is slipping is reduced, thus allowing more power from the engine 14 to pull the work machine 12 through the slip condition. The controller 60 continues to monitor the slip signal during the turn, and returns steering control back to the operator when the slip signal falls below the predetermined upper limit of slip.

Other aspects, objects, and features of the present invention can be obtained from a study of the drawings, the disclosure, and the appended claims.

1. A steering traction control apparatus for a track laying work machine supported on and operatively driven by first and second endless tracks comprising:
a first speed sensor producing a slip signal having a value responsive to the velocity of the first axle;
a second speed sensor producing a slip signal having a value responsive to the velocity of the second axle; and
a controller receives the slip signal and responsively supplies a steering output signal in response to the slip signal.

2. The steering traction control apparatus of claim 1 wherein the slip signal includes:
a value representing a ratio between the rotational velocity of the first and second drive axles.

3. The steering traction control apparatus of claim 1 wherein the steering output signal is supplied to a differential steering arrangement.

4. The steering traction control apparatus of claim 3 wherein said differential steering arrangement includes a plurality of interconnected planetary mechanisms and a fluid motor operatively connected to a one of the planetary mechanisms.

5. The steering traction control apparatus of claim 4 including a steering pump in fluid communication with the fluid motor.

6. The steering traction control apparatus of claim 5 wherein said controller responsively controls fluid output of the steering pump in response to the magnitude of the slip signal.

7. A steering traction control apparatus for a track laying work machine supported on and operatively driven by first and second endless tracks comprising:
a differential steering arrangement being operatively powering a first and a second axle supplying power to the first and second endless tracks;
a first speed sensor producing a slip signal having a value responsive to the velocity of the first axle;
a second speed sensor producing a slip signal having a value responsive to the velocity of the second axle; and
a controller receives the slip signal and responsively controls said differential steering arrangement in response to the slip signal.

8. The steering traction control apparatus of claim 7 wherein the slip signal includes:
a value representing a ratio between the rotational velocity of the first and second drive axles.

9. The steering traction control apparatus of claim 7 wherein said differential steering arrangement includes a plurality of interconnected planetary mechanisms and a fluid motor operatively connected to a one of the planetary mechanisms.

10. The steering traction control apparatus of claim 9 including a steering pump in fluid communication with the fluid motor.

11. The steering traction control apparatus of claim 10 wherein said controller responsively controls fluid output of the steering pump in response to the magnitude of the slip signal.

12. A method for controlling steering traction for a track laying work machine supported on and driven by first and second endless tracks, the first and second tracks are driven by first and second axles comprising the steps of:
producing a slip signal having a value responsive to the difference in velocity between the first and second axles; and
receiving said slip signal and producing a steering command signal in response to the magnitude of said slip signal.

13. The method, as set forth in claim 12, including the step of receiving said steering command signal and responsively operating a differential steering mechanism in response to the magnitude of said slip signal.

14. The method, as set forth in claim 12, including the step of limiting a steering control signal in response to the slip signal exceeding a predetermined upper limit.

15. The method, as set forth in claim 127 including the step of sending the steering control signal to a steering pump in said differential steering arrangement.

16. The method, as set forth in claim 15, including the step of reducing the steering pump output in response to the steering control signal.

17. The method, as set forth in claim 12, including the step of limiting further operator input in response to the slip signal exceeding the predetermined upper limit.

18. The method, as set forth in claim 12, including the step of returning steering control back to the operator when the slip signal falls below the predetermined upper limit.
